(19) United States
(12) Patent Application Publication
(10) Pub. No.: US 2024/0385790 A1
(43) Pub. Date: Nov. 21, 2024

(54) INFORMATION PROCESSING APPARATUS AND DISPLAY CONTROL METHOD

(71) Applicant: SHARP KABUSHIKI KAISHA, Sakai City (JP)

(72) Inventor: Masahiro MORISHITA, Sakai City (JP)

(21) Appl. No.: 18/659,798

(22) Filed: May 9, 2024

(30) Foreign Application Priority Data
May 17, 2023 (JP) 2023-081790

(51) Int. Cl. G06F 3/12; G06F 21/60

(52) U.S. Cl. CPC G06F 3/1267; G06F 3/1204; G06F 3/1238; G06F 21/608; G06F 2221/2137

(57) ABSTRACT

The present disclosure includes one or more controllers and a display device. The one or more controllers acquire a token from a server. In the case where a period for which the token can be used is within a determination period, a first message indicating that the token expires soon is displayed on the display device.

### BACKGROUND OF THE INVENTION

### Field of the Invention

The present disclosure relates to an information processing apparatus and the like.

### Description of the Background Art

A technique for updating an expiration date of a token used in OAuth authentication in an information processing apparatus such as an image forming apparatus has been known.

An object of the present disclosure is to provide an information processing apparatus and the like that can appropriately be operated by a user, for example.

### SUMMARY OF THE INVENTION

In order to solve the above problem, an information processing apparatus according to the present disclosure includes one or more controllers and a display device. The one or more controllers acquire a token from a server, and displays, on the display device, a first message indicating that the token expires soon in the case where a period for which the token can be used is within a determination period.

A display control method for an information processing apparatus according to the present disclosure includes: displaying, on a display device, a first message indicating that a token acquired from a server expires soon in the case where a period for which the token can be used is within a determination period.

The present disclosure can provide the information processing apparatus and the like that can appropriately be operated by a user, for example.

### BRIEF DESCRIPTION OF THE DRAWINGS

FIG. 1 is a view illustrating an overall configuration of a system according to a first embodiment.

FIG. 2 is a diagram illustrating a functional configuration of an image forming apparatus according to the first embodiment.

FIG. 3 is a table illustrating an example of a data structure of user information according to the first embodiment.

FIG. 4 is a table illustrating an example of a data structure of server information according to the first embodiment.

FIG. 5 is a table illustrating an example of a data structure of token information according to the first embodiment.

FIG. 6 is a table illustrating an example of a data structure of login information according to the first embodiment.

FIG. 7 is a table illustrating an example of a data structure of setting information according to the first embodiment.

FIG. 8A is a view illustrating an outline of processing according to the first embodiment.

FIG. 8B is a view illustrating the outline of the processing according to the first embodiment.

FIG. 9 is a flowchart of manual update processing according to the first embodiment.

FIG. 10 is a flowchart of message display processing according to the first embodiment.

FIG. 11 is a flowchart of automatic update processing according to the first embodiment.

FIG. 12A is a view illustrating an operation example according to the first embodiment.

FIG. 12B is a view illustrating an operation example according to the first embodiment.

FIG. 12C is a view illustrating an operation example according to the first embodiment.

FIG. 13A is a view illustrating an operation example according to the first embodiment.

FIG. 13B is a view illustrating an operation example according to the first embodiment.

FIG. 14 is a flowchart of automatic update processing according to a second embodiment.

FIG. 15 is a diagram illustrating a functional configuration of an image forming apparatus according to a third embodiment.

FIG. 16A is a table illustrating an example of a data structure of date and time designated transmission job information according to the third embodiment.

FIG. 16B is a table illustrating an example of a data structure of retriable job information according to the third embodiment.

FIG. 17 is a flowchart of a scan data transmission/storage processing according to the third embodiment.

FIG. 18 is a flowchart of date and time designated transmission job execution processing according to the third embodiment.

FIG. 19 is a flowchart of retriable job execution processing according to the third embodiment.

FIG. 20A is a view illustrating an operation example according to the third embodiment.

FIG. 20B is a view illustrating an operation example according to the third embodiment.

FIG. 21 is a view illustrating an operation example according to the third embodiment.

FIG. 22 is a flowchart of retriable job automatic execution processing according to a fourth embodiment.

FIG. 23 is a flowchart of processing executed by a controller according to a fifth embodiment.

FIG. 24A is a view illustrating an operation example according to the fifth embodiment.

FIG. 24B is a view illustrating an operation example according to the fifth embodiment.

FIG. 25 is a flowchart of processing executed by a controller according to a sixth embodiment.

FIG. 26A is a view illustrating an operation example according to the sixth embodiment.

FIG. 26B is a view illustrating an operation example according to the sixth embodiment.

FIG. 27A is a view illustrating an operation example of a modification of the sixth embodiment.

FIG. 27B is a view illustrating an operation example of a modification of the sixth embodiment.

### DESCRIPTION OF THE PREFERRED EMBODIMENTS

A description will hereinafter be made on embodiments of the present disclosure with reference to the accompanying drawings. The following embodiments are examples for describing the present disclosure, and the technical scope of the description in the claims is not limited to the following description.

An information processing apparatus such as an image forming apparatus (MFP, Multi-Function Peripheral/Printer) may use a resource managed by a resource server, which is an external server, when executing a job for transmitting an e-mail, and the like. The resource managed by the resource server is, for example, data or a function provided by the resource server. In this case, when the image forming apparatus uses the resource, the resource server permits login of the image forming apparatus and provides the resource to the image forming apparatus.

The resource server may use OAuth authentication when permitting the login of the image forming apparatus. In the OAuth authentication, when the apparatus or a user using the resource is authenticated, a token such as an access token issued by an authorization server is used. For example, the token is a character string including alphanumeric characters, and is information used to identify the apparatus or the user permitted to use the resource. The image forming apparatus logs in to the resource server by using the token acquired from the authorization server in advance, uses the resource managed by the resource server, and thereby executes the job such as transmission of the e-mail via the resource server.

An expiration date may be set for the token. In the following description, it is assumed that the expiration date of the token indicates a date and time when the token can no longer be used. In the case where the login date and time to the resource server is later than the expiration date of the token, that is, in the case where the token has expired, the image forming apparatus can no longer use the resource managed by the resource server and thus can no longer execute the job via the resource server.

Thus, in order to appropriately operate the image forming apparatus, it is required to newly set the expiration date of the token by updating the expiration date of the token before the token expires. Here, the image forming apparatus may be used by a plurality of users including an administrator who is a user managing the image forming apparatus and a user, such as an employee, who uses the image forming apparatus. In the case where the administrator executes operation to update the expiration date of the token and the administrator is absent, the administrator cannot update the expiration date of the token. For this reason, in the case where the token has expired, the user other than the administrator cannot execute the job via the resource server until the expiration date of the token is updated. Just as described, there is a problem that the administrator of the image forming apparatus cannot appropriately operate the image forming apparatus.

In the related art, the above-described problem has not been considered. In addition, according to the related art, the token is automatically updated when the user performs a manipulation within the expiration date of the token. However, since the expiration date of the token is updated not by the administrator's manipulation but by the user's manipulation, the image forming apparatus may be operated in a manner unintended by the administrator.

In view of such circumstances, a detailed description will hereinafter be made on a system, as an embodiment, that calls the user's attention by displaying a message indicating that the token, such as a refresh token, expires soon, so as to prompts the user to update the expiration date of the token, for example, in the case where the expiration date of the token, such as the access token or the refresh token, is close. The following embodiment is a method for solving the problem and is not limited to contents of the following disclosure.

### 1. First Embodiment

### 1.1 Overall Configuration

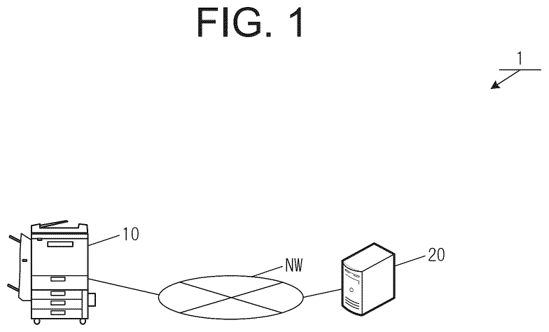

FIG. 1 is a view illustrating an overall configuration of a system 1. The system 1 is configured that an image forming apparatus 10, to which the information processing apparatus according to the present disclosure is applied, and a server device 20 are connected to a network NW. The network NW is a network such as the Internet. However, the network NW may be any network with which the devices illustrated in FIG. 1 can communicate with each other.

The image forming apparatus 10 is an information processing apparatus having a copy function, a scan function, a print function, a fax function, and the like. The image forming apparatus 10 may generally be referred to as a printer, a multifunction peripheral, a copier, a facsimile machine, an image processing apparatus, or an image output apparatus.

The server device 20 is an information processing apparatus that issues a token and provides a resource. The server device 20 can have any configuration capable of issuing the token and providing the resource. For example, the server device 20 may be constructed of a plurality of server devices including a server device that operates as an authorization server issuing the token and a server device that operates as a resource server providing the resource. A plurality of the server devices 20 may be connected to the network NW.

### 1.2 Functional Configuration

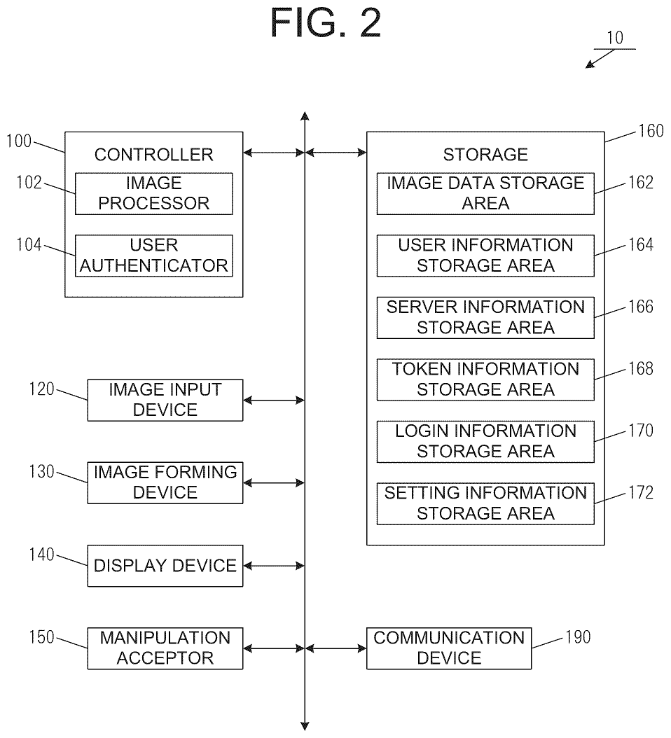

FIG. 2 is a diagram illustrating a functional configuration of the image forming apparatus 10. For example, the image forming apparatus 10 includes a controller 100, an image input device 120, an image forming device 130, a display device 140, a manipulation acceptor 150, a storage 160, and a communication device 190.

The controller 100 comprehensively controls the image forming apparatus 10. The controller 100 implements various functions by reading and executing various programs stored in the storage 160. The controller 100 may include one or more control units/arithmetic units (central processing units (CPUs)), or may include a system on a chip (SoC).

The controller 100 functions as an image processor 102 and a user authenticator 104 by executing a program stored in the storage 160.

The image processor 102 executes image processing. For example, the image processor 102 executes image processing such as sharpening processing or tone conversion processing on a document or an image input via the image input device 120 or the communication device 190.

The user authenticator 104 authenticates the user who uses the image forming apparatus 10. For example, the user authenticator 104 acquires, from the user, authentication information that is information used for authentication of the user. Then, when the acquired authentication information matches authentication information that is stored in advance in user information described below, the authenticator 104 authenticates the user as a user who uses the image forming apparatus 10.

The image input device 120 inputs an image to the image forming apparatus 10. The image input device 120 may include: a scanner device that reads a document placed on a document table; an interface (terminal) for reading an image stored in a universal serial bus (USB) memory; and the like. The scanner device converts, for example, the image into an electrical signal by using an image sensor such as a charge coupled device (CCD) or a contact image sensor (CIS), and quantizes and encodes the electrical signal.

The image forming device 130 forms (prints) an image on a recording medium such as recording paper. The image forming device 130 may include, for example, a printing device such as a laser printer using an electrophotographic method. For example, the image forming device 130 feeds the recording paper from a paper feed tray provided in the image forming apparatus 10, forms an image on a surface of the recording paper, and discharges the recording paper from a paper discharge tray provided in the image forming apparatus 10.

The display device 140 displays various types of information. For example, the display device 140 may be a display device such as a liquid-crystal display (LCD), an organic electro-luminescence (EL) display, or a micro light emitting diode (LED) display.

The manipulation acceptor 150 accepts a manipulation instruction from the user who is using the image forming apparatus 10. The manipulation acceptor 150 may include an input device such as a key switch (hard key) or a touch sensor. The touch sensor may detect, for example, an input through a contact (touch) by a general detection method such as a resistive method, an infrared method, an inductive method, or a capacitive method. The image forming apparatus 10 may have a touch panel that includes the display device 140 and the manipulation acceptor 150 integrated into one unit.

The storage 160 stores the various programs that are necessary for operation of the image forming apparatus 10 and various types of data. The storage 160 may include, for example, a storage device (auxiliary storage device) such as read only memory (ROM), random access memory (RAM), a solid state drive (SSD), which is a semiconductor memory, or a hard disk drive (HDD).

The storage 160 secures, as storage areas, an image data storage area 162, a user information storage area 164, a server information storage area 166, a token information storage area 168, a login information storage area 170, and a setting information storage area 172.

In the image data storage area 162, image data, such as scan data as data of the image of the document read via the image input device 120, is stored. The image data is formed by the image forming device 130 and transmitted by the communication device 190.

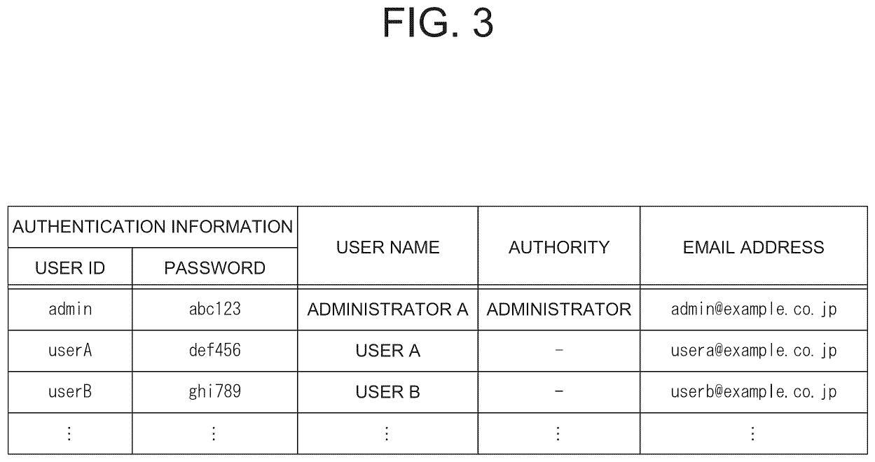

In the user information storage area 164, user information is stored. The user information is information on the user who uses the image forming apparatus 10. For example, as illustrated in FIG. 3, the user information includes an ID (for example, “admin”) for identifying the user, a password (for example, “abc123”), a user name (for example, “ADMINISTRATOR A”), authority given to the user (for example, “ADMINISTRATOR”), and the user's e-mail address (for example, “admin@example.co.jp”). In the present embodiment, the user ID and the password associated with the user ID will be referred to as the authentication information. In addition, in the present embodiment, both of a user who is given the authority of “ADMINISTRATOR” and a user who is not given the authority of “ADMINISTRATOR” are present.

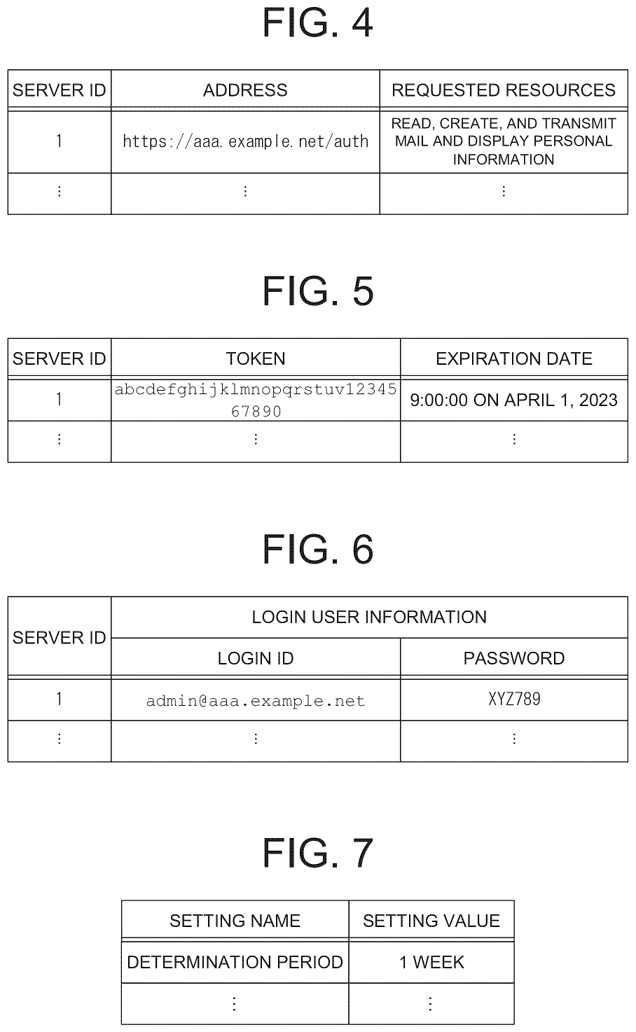

In the server information storage area 166, server information that is information on the server device 20 is stored. For example, as illustrated in FIG. 4, the server information includes a server ID (for example, “1”) for identifying the server device 20, an address of the server device 20 (for example, “https://aaa.example.net/auth”), and requested resources (for example, “READ, CREATE, AND TRANSMIT A MAIL AND DISPLAY PERSONAL INFORMATION”) indicating a resource requested by the image forming apparatus 10 to the server device 20.

The address of the server device 20 indicates a connection destination (endpoint) to be connected by the image forming apparatus 10 when a request to issue the token is made. The address of the server device 20 is a uniform resource locator (URL), for example. However, the address of the server device 20 may be an IP address, a host name, a domain name, or the like, for example, as long as being information for specifying the connection destination. Alternatively, the address of the server device 20 may be a resource name, a code or a numerical value corresponding to the resource, or the like as long as being information with which the resource can be identified.

In the token information storage area 168, token information that is information on the token is stored. For example, as illustrated in FIG. 5, the token information includes the server ID (for example, “1”), the token (for example, “abcdefghijklmnopqrstuv1234567890”) that is acquired from the server device 20 corresponding to the server ID, and the expiration date of the token (for example, “9:00:00 ON APRIL 1, 2023”).

In the login information storage area 170, login information that is information on a login to the server device 20. For example, as illustrated in FIG. 6, the login information includes the server ID (for example, “1”), a login ID (for example, “admin@aaa.example.net”) for identifying the user who logs in to the server device 20 corresponding to the server ID, and the password (for example, “XYZ789”). In the present embodiment, the login ID and the password associated with the login ID will be referred to as login user information.

In the setting information storage area 172, setting information that is information on settings of the image forming apparatus 10 is stored. For example, as illustrated in FIG. 7, the setting information includes a setting name (for example, “DETERMINATION PERIOD”) and a setting value (for example, “1 WEEK”) corresponding to the setting name.

In the present embodiment, a setting value of a determination period is stored as the setting information. The determination period is a period set with respect to a period for which the token can be used. The period for which the token can be used is a remaining period for which the token can be used, and is a period acquired by subtracting the current date and time from the expiration date of the token. The determination period may be determined in advance or may be changeable by the user. In the following description, the setting value set for the setting name “DETERMINATION PERIOD” will simply be described as the determination period.

The communication device 190 communicates with an external device such as the server device 20 via a local area network (LAN) or a wide area network (WAN). The communication device 190 may include, for example, a communication device such as a network interface card (NIC) used in a wired/wireless LAN, a communication module, and a communication interface for communicating with other devices.

### 1.3 Processing Flow

### 1.3.1 Outline of Processing

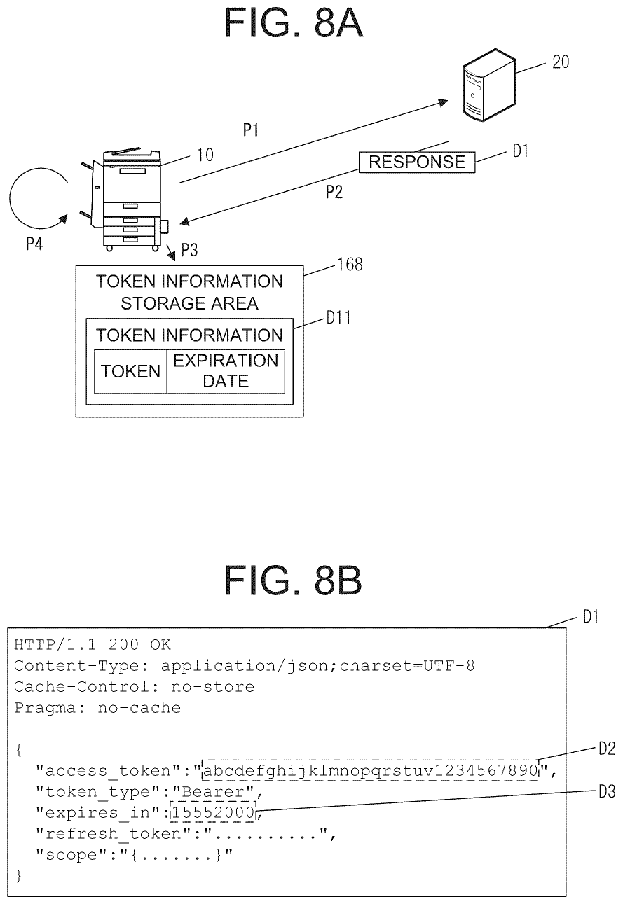

FIG. 8A is a view illustrating an overview of processing that is executed by the image forming apparatus 10. In the present embodiment, first, the image forming apparatus 10 connects to the server device 20, requests issuance of the token (P1), and receives a response D1 from the server device 20 (P2). FIG. 8B is a view illustrating an example of the response D1. The response D1 includes a token D2 and the number of seconds D3 until the token becomes unusable. The token D2 is an access token, for example. The expiration date of the token D2 is acquired by adding the number of seconds D3 to the date and time when the token D2 is issued or the date and time when the response D1 is transmitted, for example. Just as described, the image forming apparatus 10 calculates the expiration date of the token D2 by using the number of seconds D3.

The image forming apparatus 10 stores, in the token information storage area 168, token information D11 that includes the token D2 included in the response D1 and the expiration date of the token D2 (P3).

In addition, the image forming apparatus 10 determines whether the period for which the token can be used is within the determination period (P4). In the case where the period for which the token can be used is within the determination period, the image forming apparatus 10 displays a message indicating that the token expires soon.

### 1.3.2 Processing of Image Forming Apparatus

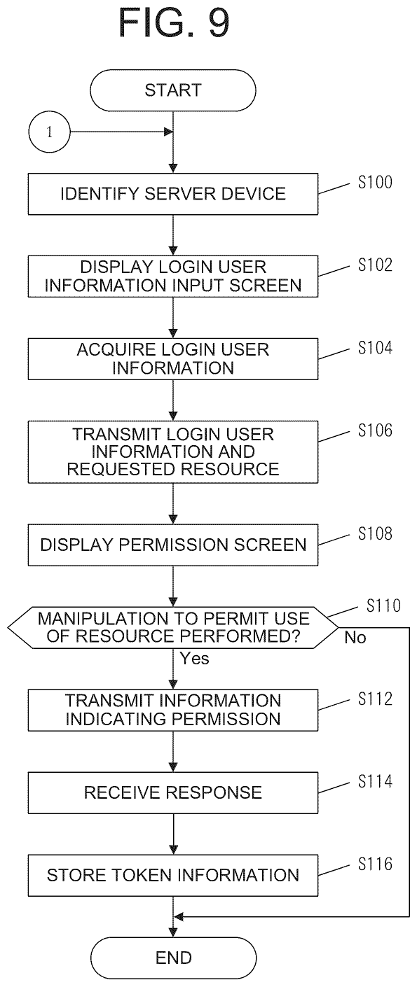

FIGS. 9 to 11 are flowcharts of processing executed by the controller 100 of the image forming apparatus 10. In the following description of the processing, it is assumed that the user information, the server information, and the setting information are stored in advance in the storage 160 of the image forming apparatus 10.

### 1.3.2.1 Manual Update Processing

FIG. 9 is a flowchart illustrating a flow of manual update processing that is executed when the user manually updates the expiration date of the token.

First, the controller 100 identifies the token for which the expiration date is to be updated, and identifies the server device 20 that requests the issuance of the token (step S100). For example, in the case where the user instructs execution of the processing that requires the token, or in the case where the user selects the token for which the expiration date is to be updated, the controller 100 identifies the server device 20, which corresponds to the token for which the expiration date is to be updated, in response to the user's manipulation.

Next, the controller 100 displays a login user information input screen on the display device 140 (step S102), and acquires the login user information input by the user via the input screen (step S104).

Next, the controller 100 transmits the login user information acquired in step S104 and the requested resource corresponding to the server device 20 to the address of the server device 20 identified in step S100 as the connection destination (step S106).

Here, in the case where the login to the server device 20 is successfully completed after the processing in step S106, the controller 100 receives, from the server device 20, data used to display a permission screen for selecting whether to permit use of the requested resource. The data used for display is HyperText Markup Language (HTML) data, for example. The controller 100 displays the permission screen on the display device 140 on the basis of the data user for display (step S108).

Next, the controller 100 determines whether the user has performed a manipulation to permit the use of the resource via the permission screen (step S110).

In the case where the manipulation to permit the use of the resource has been performed, the controller 100 transmits information indicating that the use of the resource is permitted to the server device 20 identified in step S100 (step S110; Yes→step S112). In addition, the controller 100 receives a response to the processing in step S112 from the server device 20 identified in step S100 (step S114), and stores the token information on the basis of the response (step S116). For example, the controller 100 stores, in the token information storage area 168, the token information that includes the token included in the response received from the server device 20 and the expiration date calculated on the basis of the number of seconds included in the response. In this way, the controller 100 updates the expiration date of the token.

If the user has performed a manipulation to reject the use of the resource in step S110, the controller 100 omits the processing from step S112 to step S116 (step S110; No).

### 1.3.2.2 Message Display Processing

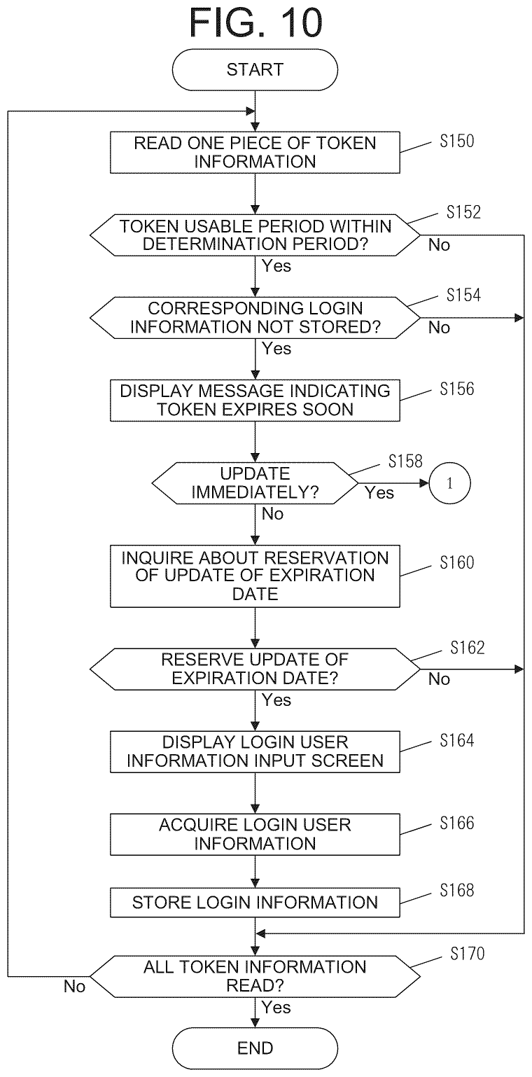

FIG. 10 is a flowchart illustrating a flow of message display processing to display the message indicating that the token expires soon.

First, the controller 100 reads one piece of the token information from the token information storage area 168 (step S150). In the following description of the message display processing, the token that is included in the token information read in step S150 is referred to as a “target token”.

Next, the controller 100 determines whether a period for which the target token can be used is within the determination period (step S152). For example, the controller 100 calculates the period for which the target token can be used by subtracting the date and time (current date and time) on which the processing in step S152 is executed from the expiration date of the target token. If the period for which the target token can be used is within the determination period, the controller 100 determines whether the login information that corresponds to the token information read in step S150 is stored in the login information storage area 170 (step S152; Yes→step S154). The login information corresponding to the token information is the login information that includes the same server ID as the server ID included in the token information.

If the login information corresponding to the token information is not stored, the controller 100 displays the message (first message) indicating that the target token expires soon (step S156). At this time, the controller 100 inquires of the user whether to perform a manipulation to update (immediately update) the expiration date of the target token.

If the user selects performing the manipulation to update the expiration date of the target token, the processing proceeds to step S100 in FIG. 9 (step S158; Yes→step S100). In this way, the controller 100 causes the user to manually update the expiration date of the target token.

On the other hand, if the user selects not to perform the manipulation to update the expiration date of the target token, the controller 100 inquires of the user whether to reserve update of the expiration date of the target token (step S158; No→step S160).

If the user selects to reserve the update of the expiration date of the token (step S162; Yes), the controller 100 displays the login user information input screen on the display device 140 (step S164).

Next, the controller 100 acquires the login user information input via the input screen (step S166). Then, the controller 100 stores, in the login information storage area 170, the login information that includes the acquired login user information as the login information that corresponds to the token information read in step S150 (step S168).

If the period for which the target token can be used exceeds the determination period (step S152; No), and if the login information corresponding to the token information read in step S150 is not stored (step S154; No), the controller 100 omits the processing from step S156 to step S168. In addition, if the user does not reserve the update of the expiration date of the token in step S162, the controller 100 omits the processing from step S164 to step S168 (step S164; No).

Next, the controller 100 determines whether all the token information stored in the token information storage area 168 has been read (step S170). If all the token information stored in the token information storage area 168 has been read, the controller 100 terminates the processing illustrated in FIG. 10 (Step S170; Yes). On the other hand, if not all the token information stored in the token information storage area 168 has been read, the processing returns to Step S150 (Step S170; No→Step S150). At this time, in step S150, the controller 100 reads one piece of the token information that has not been read since the start of the processing illustrated in FIG. 10.

The controller 100 executes the processing illustrated in FIG. 10 periodically (for example, at 9 a.m. every day). Accordingly, the controller 100 can periodically display the message when the period for which the token can be used is within the determination period.

### 1.3.2.3 Automatic Update Processing

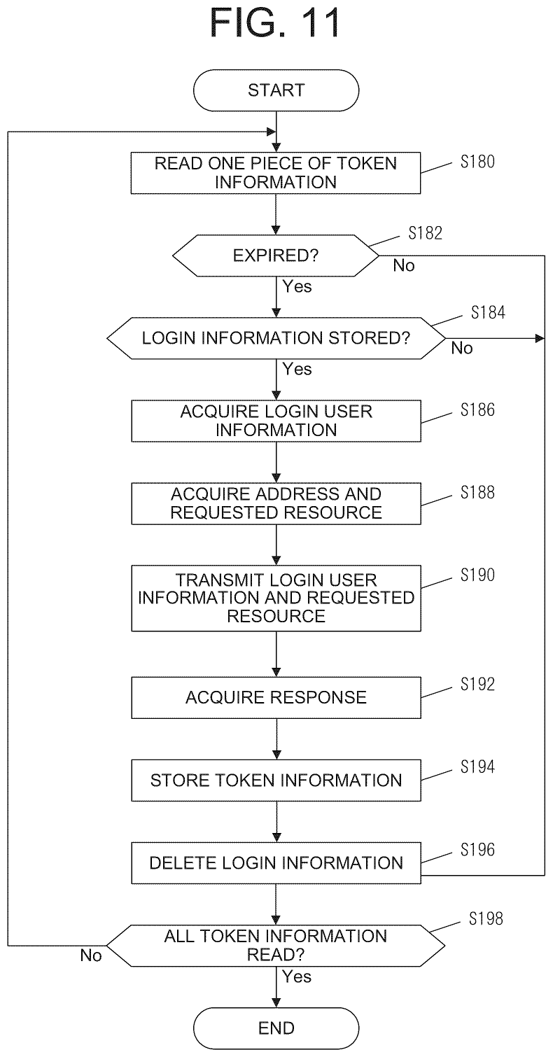

FIG. 11 is a flowchart illustrating a flow of automatic update processing for automatically updating the expiration date of the token. First, the controller 100 reads one piece of the token information from the token information storage area 168 (step S180), and determines whether the token included in the token information has expired (step S182).

If it is determined that the token has expired, the controller 100 determines whether the login information that corresponds to the token information read in step S180 is stored in the login information storage area 170 (step S182; No→step S184).

If it is determined that the login information is stored, the controller 100 acquires the login user information from the login information (step S184; Yes→step S186). Then, the controller 100 acquires the address and the required resource from the server information that corresponds to the token information read in step S180 (step S188). The server information corresponding to the token information is the server information that includes the same server ID as the server ID included in the token information.

Next, the controller 100 transmits the login user information acquired in step S188 and the requested resource corresponding to the server device 20 to the address acquired in step S188 as the connection destination (step S190). In the processing of step S190, the controller 100 automatically performs a required manipulation to receive the response from the server device 20 by automatically inputting the login user information on the login user information input screen or automatically performing the manipulation to permit the use of the resource on the permission screen. At this time, in the case where a trouble occurs during the automatic manipulation, the controller 100 may notify the user having the administrator authority of the occurrence of the trouble by e-mail or the like.

Next, the controller 100 receives the response to the processing in step S190 from the server device 20 (step S192), and stores the token information on the basis of the response (step S194). Then, the controller 100 deletes the login information that corresponds to the token information read in step S180 from the login information storage area 170 (step S196).

If it is determined that the token has not expired (step S182; No), and if the login information that corresponds to the token information read in step S180 is not stored (step S184; No), the controller 100 omits the processing from step S186 to step S196.

Next, the controller 100 determines whether all the token information stored in the token information storage area 168 has been read (step S198). Then, if determining that all the token information has been read, the controller 100 terminates the processing illustrated in FIG. 11 (step S198; Yes). On the other hand, if the controller 100 determines that not all the token information has been read, the processing returns to step S180 (step S198; No→step S180). Then, in step S180, the controller 100 reads one piece of the token information that has not been read since the start of the processing illustrated in FIG. 11.

The controller 100 executes the processing illustrated in FIG. 11 periodically (for example, at 9 a.m. every day). In this way, the controller 100 can automatically update the expiration date of the token.

### 1.4 Operation Example

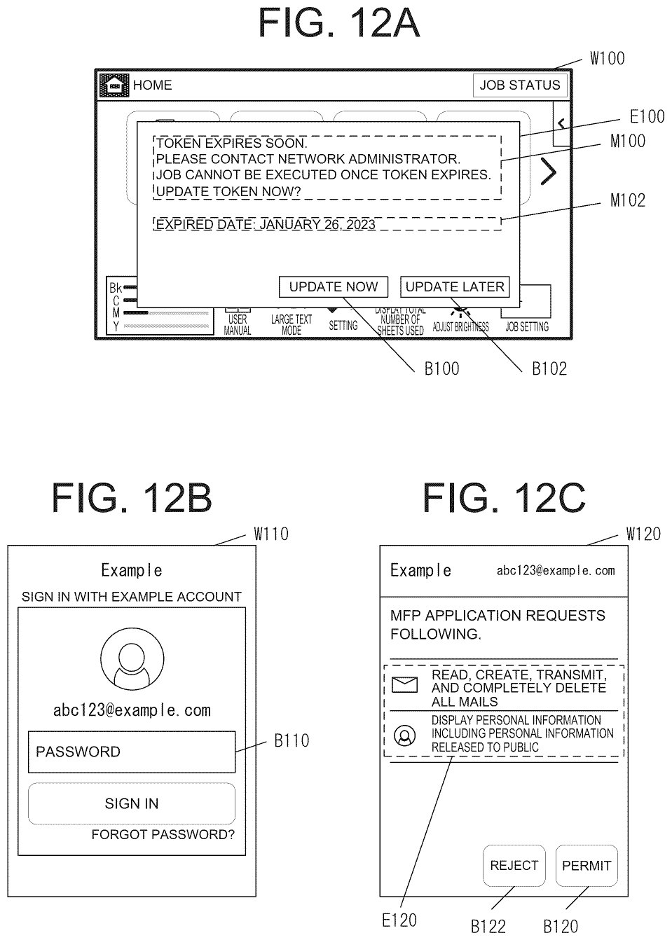

FIG. 12A is a view illustrating a display example of a screen W100 that is displayed on the display device 140 when the period which the token can be used is within the determination period. A pop-up window E100 is displayed on the screen W100, and includes a message M100 indicating that the token expires soon and an expiration date M102 of the token.

The pop-up window E100 includes a button B100 for instructing to update the expiration date of the token now and a button B102 for instructing to update the expiration date of the token later. By selecting the button B100, the user can immediately update the expiration date of the token by manipulating the image forming apparatus 10 on the spot.

When the button B100 is selected, a login user information input screen W1 illustrated in FIG. 12B is displayed on the display device 140. The input screen W1 includes a text box B110 for inputting a password, for example. When the login to the server device 20 is successfully completed, a permission screen W120 illustrated in FIG. 12C is displayed on the display device 140. The permission screen W120 includes an area E120 for displaying information on the requested resource, such as the name and description of the requested resource, a button B120 for instructing to permit the use of the requested resource, and a button B122 for instructing to reject the use of the resource. By selecting the button B120, the user can update the expiration date of the token.

In the case where the user who selects the button B100 is not the user having the administrator authority, or whether such a user has the administrator authority cannot be determined, the image forming apparatus 10 may authenticate the user by the user authenticator 104. In the case where the user authenticator 104 can authenticate the user having the administrator authority, the image forming apparatus 10 may be able to update the expiration date of the token.

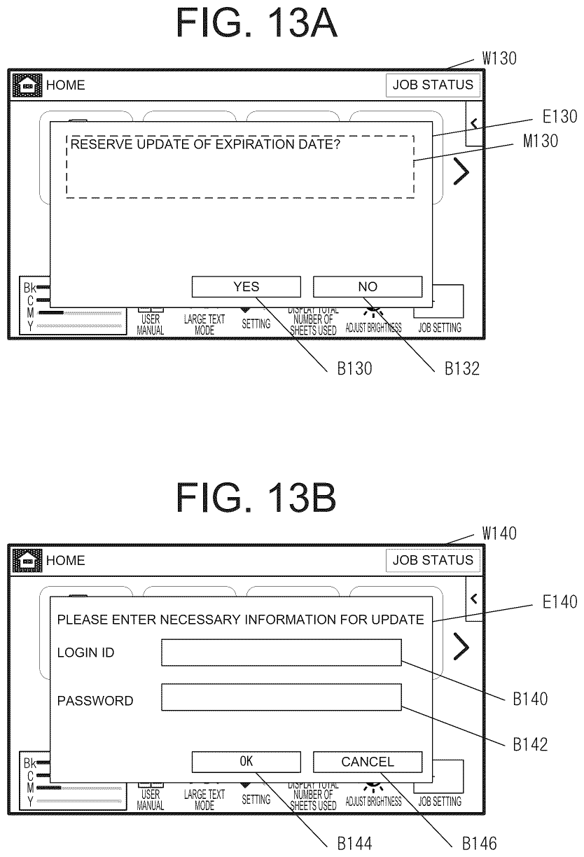

FIG. 13A is a view illustrating a screen example of a screen W130 that is displayed on the display device 140 when the button B102 is selected on the screen W100 illustrated in FIG. 12A. A pop-up window E130 is displayed on the screen W130, and includes a message M130 for inquiring whether to reserve the update of the token, a button B130 for instructing to reserve the update of the token, and a button B132 for instructing not to reserve the update of the token.

When the user selects the button B130, a login user information input screen W140 as illustrated in FIG. 13B is displayed on the display device 140. The user inputs values in a text box B140 for inputting the login ID and a text box B142 for inputting the password, and selects an OK button B144 to store the login user information in the image forming apparatus 10. The login user information stored by the user's manipulation is transmitted to the server device 20 when the image forming apparatus 10 executes the automatic update processing.

When the button B132 is selected on the screen W130, the pop-up window E130 is not displayed, and the update of the expiration date of the token is not reserved. Similarly, when the cancel button B146 is selected on the input screen W140, the pop-up window E140 is not displayed, and the update of the expiration date of the token is not reserved.

The controller 100 may indicate that the token expires soon by a method other than the method of displaying the message. For example, in the case where the controller 100 includes a state display lamp that indicates a state of the image forming apparatus 10 by a lighting state of the lamp, the controller 100 may indicate that the token expires soon by lighting the state display lamp in a predetermined color or by a predetermined lighting method.

In the above description, the period for which the token can be used is calculated by subtracting the current date and time from the expiration date of the token, but may be calculated by a method other than such a method. For example, the period for which the token can be used may be calculated by subtracting the number of seconds elapsed from the acquisition of the token from the number of seconds until the token becomes unusable, which is included in the response acquired from the server device 20. In this case, for example, the image forming apparatus 10 may store the token and the number of the seconds until the token becomes unusable as the token information, and may execute processing to appropriately subtract the number of the seconds until the token becomes unusable.

As described above, the image forming apparatus according to the present embodiment periodically checks the expiration date of the token before the token expires. Then, when the token expires soon, the image forming apparatus displays the message and can thereby call the user's attention. By checking the message, the user can update the expiration date of the token before the token expires. Thus, the user can cause the image forming apparatus to execute the job via the resource server without delay. As a result, the user can continue the operation of the image forming apparatus without stopping the image forming apparatus.

In addition, since the job via the resource server is executed without delay, it is possible for the user to reduce possible occurrence of work such as ascertaining a cause of failure of the job via the resource server and possible occurrence of loss of sales due to delay caused by the work.

In addition, the image forming apparatus according to the present embodiment updates the expiration date of the token after acquiring the login user information. Thus, for example, it is possible to prevent the update of the expiration date of the token at timing that is not intended by the user having the administrator authority.

### 2. Second Embodiment

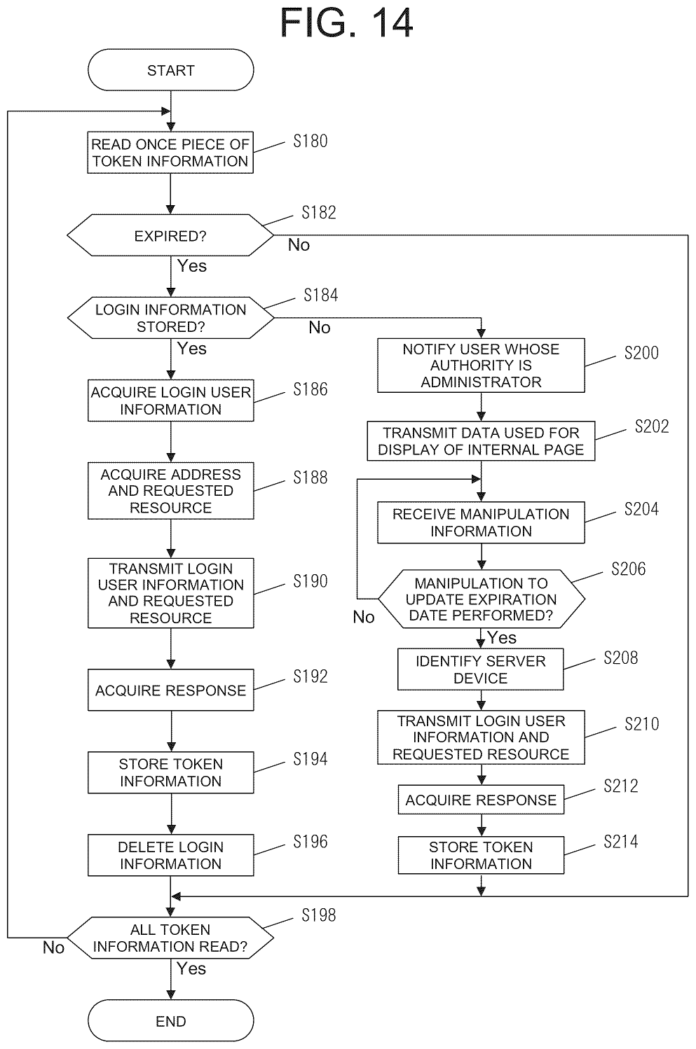

The second embodiment is an embodiment in which, in the image forming apparatus 10 according to the first embodiment, the expiration date of the token can be updated remotely when the token expires. The present embodiment is an embodiment in which FIG. 11 of the first embodiment is replaced with FIG. 14. The same processing will be denoted by the same reference sign, and the description thereon will not be made.

### 2.1 Functional Configuration

It is assumed that the image forming apparatus 10 according to the present embodiment can provide a dedicated web page (hereinafter, referred to as an internal page) that enables the manipulation on the image forming apparatus 10. When access to the internal page is requested from another apparatus, the image forming apparatus 10 transmits data used for display of the internal page to the other apparatus. In addition, the image forming apparatus 10 receives, from the other apparatus, information on a content of the manipulation performed on the internal page by the user, and reflects the manipulation performed by the user in the image forming apparatus 10 on the basis of the information. The apparatus connected to the image forming apparatus 10 may be a general information processing device or a terminal device such as a PC, a tablet, or a smartphone.

### 2.2 Processing Flow

FIG. 14 is a flowchart illustrating a flow of the automatic update processing according to the present embodiment. In the present embodiment, if the login information that corresponds to the token information read in step S180 is not stored, the controller 100 notifies the user having the administrator authority that the token has expired (step S184; No→step S200). For example, the controller 100 transmits, to the e-mail address of the user whose authority is the “administrator”, an e-mail including, in a body: a message indicating that the token has expired; or a URL for accessing the internal page as information used to update the token. As a result, the controller 100 transmits the information used to update the token to the apparatus used by the user whose authority is the “administrator”.

Next, when the access to the internal page is requested by the other apparatus, the controller 100 transmits the data used for display of the internal page to the other apparatus (step S202). Then, the controller 100 receives information on the content of the manipulation performed on the internal page by the user (step S204). Examples of the information on the content of the manipulation are information on the button in the internal page selected by the user and information on a character string input to a text box included in the internal page.

Next, based on the information received in step S204, the controller 100 determines whether the manipulation to update the expiration date of the token has been performed (step S206). If determining that a manipulation other than the manipulation to update the expiration date of the token has been performed, the controller 100 reflects such a manipulation in the image forming apparatus 10, and the processing returns to step S204 (step S206; No→step S204).

On the other hand, if determining that the manipulation to update the expiration date of the token has been performed, the controller 100 identifies the server device 20 that requests the issuance of the token (step S206; Yes→step S208). Then, the controller 100 transmits the login user information and the requested resource corresponding to the server device 20 to the server device 20 specified in step S208 (step S210). For example, the controller 100 includes a text box for inputting the login user information in the internal page, and thereby acquires the character string input in the text box as the login user information.

Next, the controller 100 receives a response to the processing in step S210 from the server device 20 (step S212), and stores the token information on the basis of the response (step S214).

Instead of causing the other apparatus to display the internal page, the image forming apparatus 10 may cause the other apparatus to display the screen itself that is displayed on the display device 140 of the image forming apparatus 10. In this case, in step S200, the controller 100 may notify the user of a URL or the like, from which data for displaying the screen to be displayed on the display device 140 can be acquired, as information used to update the token remotely. Then, when the other apparatus requests the access to the URL, the controller 100 may transmit data for displaying the screen to be displayed on the image forming apparatus 10 to the other apparatus.

As another example of manipulating the image forming apparatus 10 remotely, a first user may perform a manipulation of a user interface (UI) for the image forming apparatus 10 performed to update the expiration date of the token, and a second user having the administrator authority may only input the login user information remotely. For example, when the first user performs the manipulation to update the expiration date of the token, the image forming apparatus 10 inquires of the second user about the login user information by e-mail or the like. The image forming apparatus 10 updates the expiration date of the token by transmitting the login user information, which has been transmitted by the second user, to the server device 20 and receiving the response from the server device 20.

As described above, even in the case where the token has expired, the image forming apparatus according to the present embodiment can notify the user having the administrator authority that the token has expired, and can prompt the user to update the expiration date of the token in a timely manner. In addition, the image forming apparatus according to the present embodiment enables the expiration date of the token to be updated remotely. As a result, even when the user having the administrator authority is not present at a location where the image forming apparatus is installed, the user can quickly restore the image forming apparatus. Thus, it is possible to shorten a time for which the image forming apparatus cannot be used and a time for which the job cannot be executed. As described above, the image forming apparatus according to the present embodiment enables the user to appropriately perform recovery after the expiration of the token, which cannot be realized by the related art.

### 3. Third Embodiment

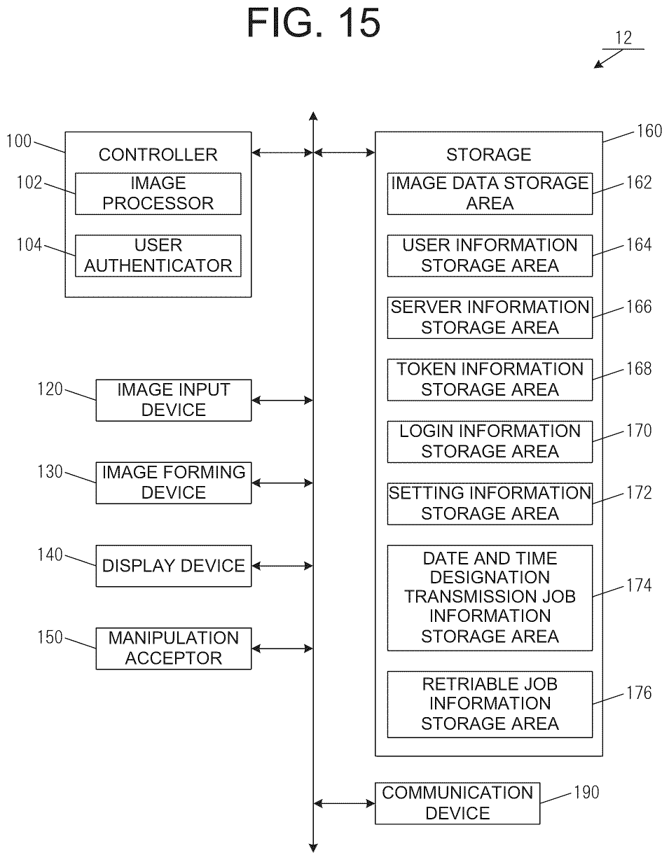

A third embodiment is an embodiment in which, in addition to the processing described in the first embodiment, processing to display a message is executed in the case where timing of executing the job is later than the expiration date of the token. The present embodiment is an embodiment in which FIG. 2 of the first embodiment is replaced with FIG. 15. The same functional devices will be denoted by the same reference signs, and the description thereon will not be made.

The jobs executed by the image forming apparatus include a date and time designation job that is a job enabling the execution of the job on the date and time designated by the user. The user can reserve execution of a specific job by using such an image forming apparatus.

Here, in the case where the date and time designation job using the resource managed by the resource server is executed in the general image forming apparatus, the execution of the date and time designation job fails when it is impossible to log in to the resource server due to the expiration of the token. In this case, when the user reserves the execution of the job, the user thinks that the job is to be executed on the designated date and time. However, the user suffers from a disadvantage that the job is not actually executed.

Accordingly, in the present embodiment, in the case where the execution date and time of the date and time designation job is later than the expiration date of the token, a message is displayed to enable the user to avoid the above-described disadvantage.

Hereinafter, a description will be made on, as an example of the date and time designation job, a case where the date and time designation job is a date and time designated transmission job for transmitting scan data to a designated transmission destination on a designated transmission date and time. That is, the date and time designated transmission job is a type of a scan job and is particularly a job in which the transmission date and time and the transmission destination are designated.

### 3.1 Functional Configuration

In the present embodiment, an image forming apparatus 12 is used instead of the image forming apparatus 10. FIG. 15 is a view illustrating a functional configuration of the image forming apparatus 12. The image forming apparatus 12 is different from the image forming apparatus 10 in that a date and time designated transmission job information storage area 174 and a retriable job information storage area 176 are further secured in the storage 160.

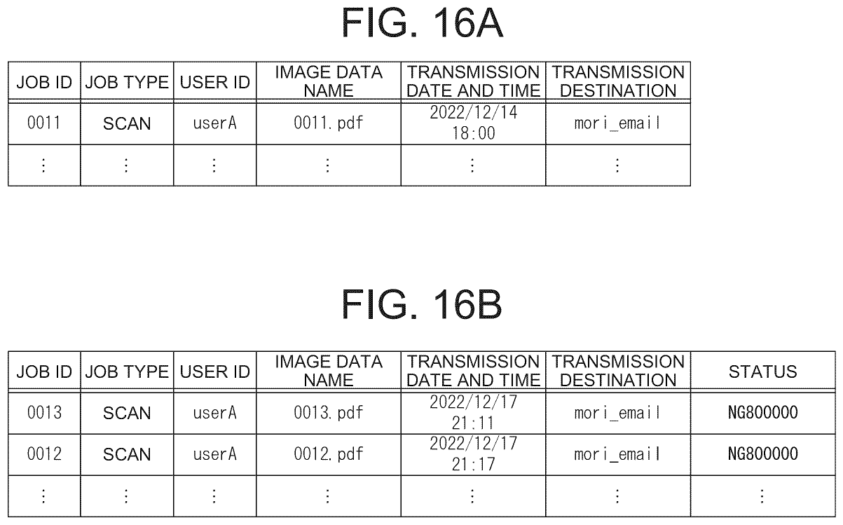

In the date and time designated transmission job information storage area 174, the date and time designated transmission job information is stored, and is information on the date and time designated transmission job. As illustrated in FIG. 16A, the date and time designated transmission job information includes a job ID (for example, “0011”) for identifying the job, a job type (for example, “SCAN”), the user ID (for example, “userA”) for identifying the user who has instructed the execution of the job, an image data name (for example, “0011.pdf”) of the scan data corresponding to the job, the transmission date and time (for example, “2022/12/14 18:00”) designated as a date and time for transmitting the scan data, and the transmission destination (for example, “mori_email”) of the scan data.

The scan data is stored in the image data storage area 162 and is identified by the image data name. The transmission destination may be any information, a mail address, a FAX number, an Internet Protocol (IP) address of an apparatus as the transmission destination, or a name of the apparatus, with which the transmission destination can be identified.

In the retriable job information storage area 176, retriable job information is stored and is information on a retriable job. The retriable job is a job, the execution of which has failed, and which can be retried (re-executed), among the date and time designation jobs. As illustrated in FIG. 16B, the retriable job information is generated by including information on a status (for example, “NG800000”) in the date and time designated transmission job information. As the status, for example, a code indicating the job status or a reason why the execution of the job has failed is stored.

### 3.2 Processing Flow

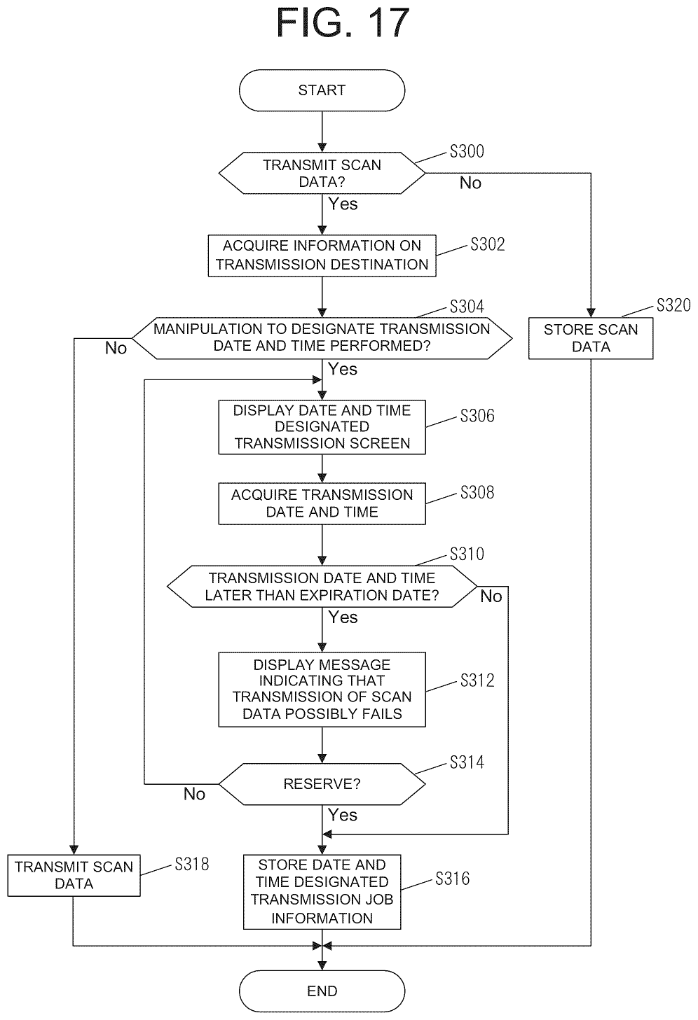

The controller 100 of the image forming apparatus 12 executes processing illustrated in FIGS. 17 to 19 in addition to the processing illustrated in FIGS. 9 to 11 of the first embodiment.

### 3.2.1 Scan Data Transmission/Storage Processing

FIG. 17 is a flowchart illustrating a flow of scan data transmission/storage processing. In the case where the user uses the scan function, the scan data transmission/storage processing is executed after the image forming apparatus 12 acquires the scan data.

First, the controller 100 determines whether the user has selected to transmit the scan data (step S300).

If determining that the user has selected to transmit the scan data, the controller 100 acquires information on the transmission destination designated by the user (step S302). For example, the controller 100 displays, on the display device 140, a screen for inputting the scan data transmission destination and acquires the mail address input by the user, the server name, and a file path of the other apparatus as the information on the scan data transmission destination.

Next, the controller 100 determines whether the user has performed a manipulation to designate the transmission date and time of the scan data (step S304). That is, it is determined whether the user has reserved the execution of the job for transmitting the scan data on the designated date and time.

If determining that the manipulation to designate the transmission date and time of the scan data has been performed, the controller 100 displays a date and time designated transmission screen that is a screen for designating the transmission date and time of the scan data (step S304; Yes→step S306). Then, the controller 100 acquires the transmission date and time designated by the user via the date and time designated transmission screen (step S308).

Next, the controller 100 compares the transmission date and time with the expiration date stored in the token information, in which the token used for transmission of the scan data is stored, and determines whether the transmission date and time is later than the expiration date of the token (step S310). If the transmission date and time is later than the expiration date of the token, the controller 100 displays a message (second message) indicating that the scan data transmission possibly fails on the display device 140 (step S310; Yes→step S312). That is, the controller 100 displays a message indicating that the execution of the job possibly fails. At this time, the controller 100 inquires of the user whether to reserve the execution of the job for transmitting the scan data even with a possibility that the transmission of the scan data fails.

Next, the controller 100 determines whether the user has selected to reserve the execution of the job for transmitting the scanned data (step S314). If the controller 100 determines that the user has not selected to reserve the execution of the job for transmitting the scan data, the processing returns to step S306 (step S314; No→step S306). That is, the controller 100 causes the user to reset the transmission date and time. On the other hand, if determining that the user has reserved the execution of the job, the controller 100 stores the information on the job for transmitting the scan job as the date and time designated transmission job in the date and time designated transmission job information storage area 174 (step S314; Yes→step S316).

In step S310, if the transmission date and time is before the expiration date of the token, the processing in step S312 and step S314 is omitted (step S310; No).

In step S304, if determining that the manipulation to designate the date and time has not been performed, the controller 100 transmits the scan date to the transmission destination designated by the user (step S304; No→step S318). In addition, in step S300, if the transmission of the scan data has not been selected, the controller 100 stores the scan data in the image data storage area 162 (step S300; No→step S320).

### 3.2.2 Date and Time Designated Transmission Job Execution Processing

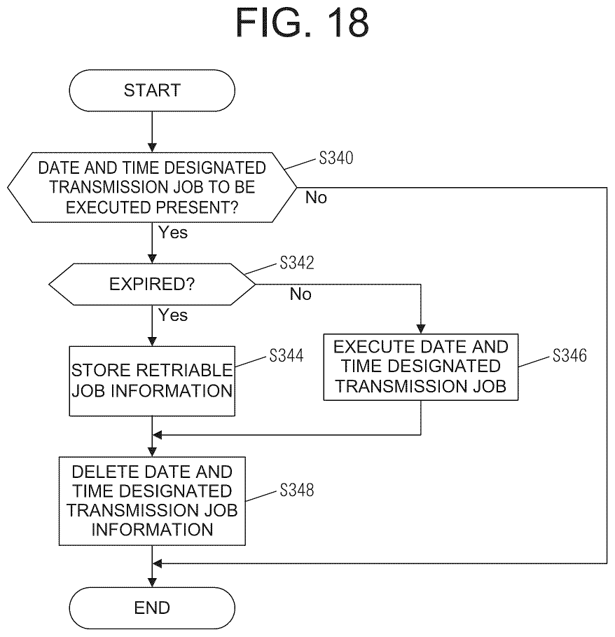

FIG. 18 is a flowchart illustrating a flow of processing for executing the date and time designated transmission job. First, the controller 100 determines whether the date and time designated transmission job information, which corresponds to the date and time designated transmission job to be executed, is stored in the date and time designated transmission job information storage area 174 (step S340). The date and time designated transmission job to be executed is the date and time designated transmission job whose transmission date and time is earlier than the current date and time.

If determining that the date and time designated transmission job information is stored, the controller 100 compares the current date and time with the expiration date of the token used for the transmission of the scan data, and determines whether the token has expired (step S342).

If determining that the token has expired, the controller 100 stores, in the retriable job information storage area 176, the date and time designated transmission job information that corresponds to the date and time designated transmission job to be executed (step S342; Yes→step S344).

On the other hand, if determining that the token has not expired, the controller 100 executes the date and time designated transmission job to be executed (step S342; No→step S346). In addition, the controller 100 deletes the date and time designated transmission job information, which corresponds to the date and time designated transmission job executed in step S346, from the date and time designated transmission job information storage area 174 (step S348).

By executing the processing illustrated in FIG. 18 periodically (for example, every minute), the controller 100 can execute processing for transmitting the scan data on the designated transmission date and time by the user, or processing for setting the date and time designated transmission job as the retriable job. The controller 100 can set the date and time designated transmission job in a standby state by setting the date and time designated transmission job as the retriable job.

### 3.2.3 Retriable Job Execution Processing

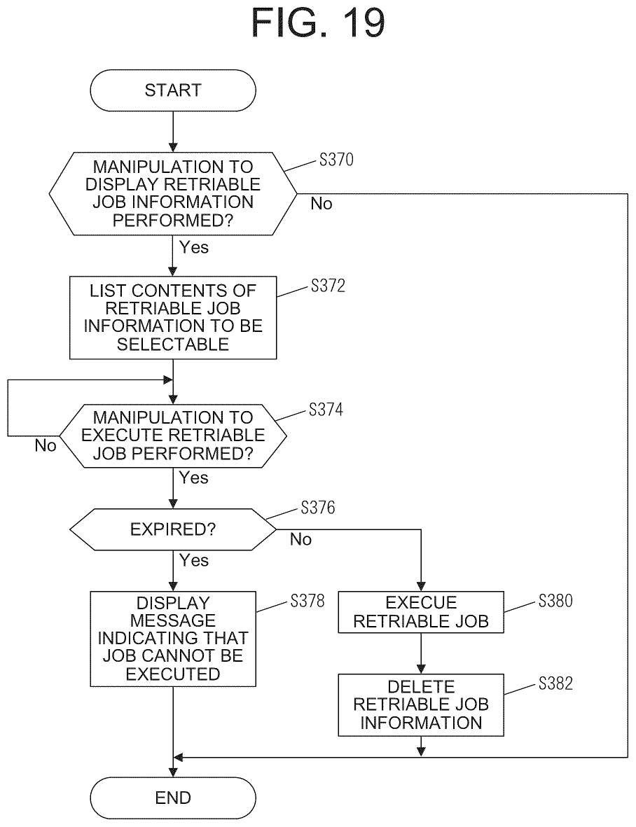

FIG. 19 is a flowchart illustrating a flow of processing for executing the retriable job. First, the controller 100 determines whether the user has performed a manipulation to display the retriable job information (step S370). For example, the controller 100 displays a button for listing the retriable jobs on the display device 140. Then, if the button is selected, the controller 100 determines that the manipulation to display the retriable job information has been performed.

If the manipulation to display the retriable job information has been performed, the controller 100 displays a list of contents of the retriable job information, which is stored in the retriable job information storage area 176, in a selectable manner (step S370; Yes→step S372).

Next, the controller 100 determines whether the user has performed a manipulation to instruct execution of the retriable job (step S374). For example, the manipulation to instruct the execution of the retriable job is a manipulation to select one or more contents of the retriable job information on the list and select a button, such as a start button, for executing the job. If determining that the manipulation to instruct the execution of the retriable job has not been performed, the controller 100 repeatedly executes the processing in step S374 (step S374; No).

On the other hand, if determining that the manipulation to instruct the execution of the retriable job has been performed, the controller 100 determines whether the token used for the execution of the retriable job has expired (step S374; Yes→step S376). If determining that the token has expired, the controller 100 displays a message indicating that the retriable job selected by the user cannot be executed on the display device 140 (step S376; Yes→step S378). On the other hand, if determining that the token has not expired, the controller 100 executes the retriable job, for which the manipulation to instruct the execution has been performed by the user (step S376; No→step S380). Then, the controller 100 deletes the retriable job information that corresponds to the retriable job executed in step S380 from the retriable job information storage area 176 (step S382).

If the manipulation to display the retriable job information has not been performed, the processing from step S372 to step S382 is omitted (step S370; No).

### 3.3 Operation Example

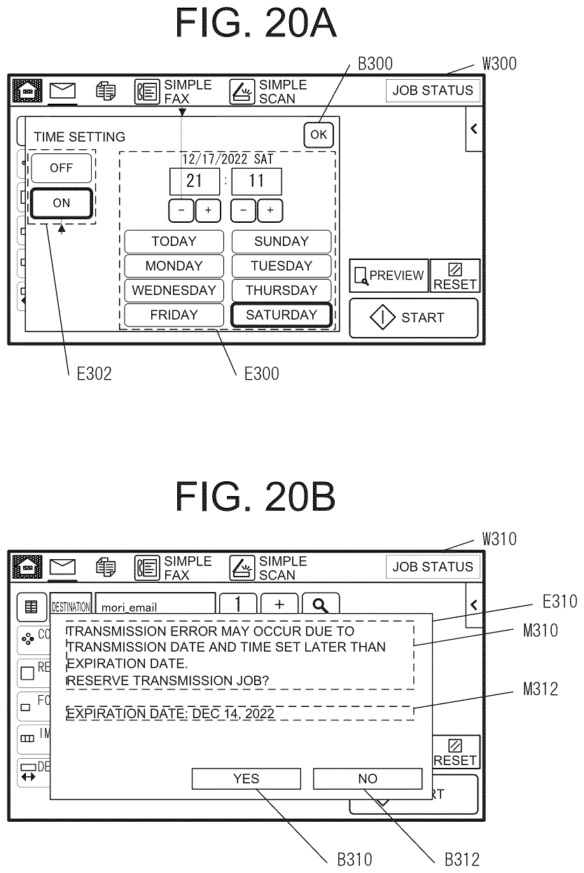

FIG. 20A is a view illustrating a display example of a date and time designated transmission screen W300. On the date and time designated transmission screen W300, the user selects the transmission date and time by manipulating a UI in an area E300 that includes a UI for selecting the transmission date and time. Then, the user selects an OK button B300 to designate the transmission date and time of the scan data. The date and time designated transmission screen W300 may include an area E302 that includes a UI for selecting whether to designate the transmission date and time.

FIG. 20B is a view illustrating a display example of a screen W310 that is displayed when the transmission date and time is later than the expiration date of the token. A pop-up window E310 is displayed on the screen W310, and includes a message M310 indicating that the transmission of the scan data possibly fails.

For example, the message M310 may include a sentence describing a cause of transmission failure of the scan data, such as “TRANSMISSION ERROR MAY OCCUR DUE TO TRANSMISSION DATE AND TIME SET LATER THAN EXPIRATION DATE”. In addition, the message M310 may include a sentence that inquires of the user, such as “JOB IS EXECUTED AFTER EXPIRATION OF TOKEN USED FOR OAuth AUTHENTICATION. TRANSMISSION ERROR MAY OCCUR, BUT WISH TO RESERVE?” Furthermore, an expiration date M312 of the token may be displayed together with the message M310.

A button B310 for instructing to reserve the execution of the job for transmitting the scan data and a button B312 for instructing not to reserve the execution of the job for transmitting the scan data may be displayed together with the message M310. By selecting the button B310, the user can reserve the execution of the job for transmitting the scan data even in the case where the transmission of the scan data possibly fails. When the button B312 is selected, the pop-up window E310 is not displayed, and the transmission date and time can be set again.

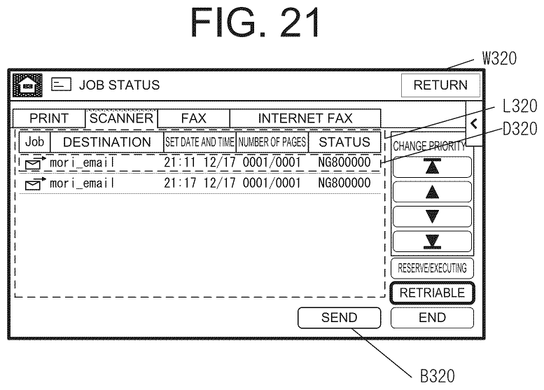

FIG. 21 is a view illustrating a screen example of a screen W320 on which the retriable job information is listed in the selectable manner. For example, the screen W320 includes a list L320 for displaying the retriable job information. In the list L320, contents of the retriable job information are displayed as selectable items. For example, an item D320 includes, as the contents of the retriable job information, an icon indicating a job type, the transmission destination (destination), the transmission date and time (set date and time), and the status. In addition, as illustrated in the item D320, the number of pages of the scan data may be displayed. In addition to the above-described contents, the items of the list L320 may include information such as the user ID, the user name, and a file name of the scan data, and the like. Thus, the user can check the detailed information on the retriable job.

The user selects the retriable job information by selecting the one or more items from the list L320. In addition, the user can execute the retriable job that corresponds to the selected retriable job information by selecting a send button B320.

However, the retriable job may only be executable by the user having the administrator authority. In addition, such a retriable job may only be executable that corresponds to the date and time designated transmission job reserved by the user who uses the image forming apparatus 12.

The above description has been made on the case where the date and time designation job is the date and time designated transmission job. However, the date and time designation job may be any job, the execution date and time of which is designated.

As described above, the image forming apparatus according to the present embodiment can call the user's attention by displaying the message in the case where the token expires before the date and time designation job is executed. The user can grasp in advance the possibility that the date and time designation job is not executed, Thus, it is possible to reduce the possibility of suffering the disadvantage that the date and time designation job is not executed due to the relationship with the expiration date of the token.

### 4. Fourth Embodiment

A fourth embodiment is an embodiment in which the retriable job described in the third embodiment is automatically executed at timing when the expiration date of the token is updated.

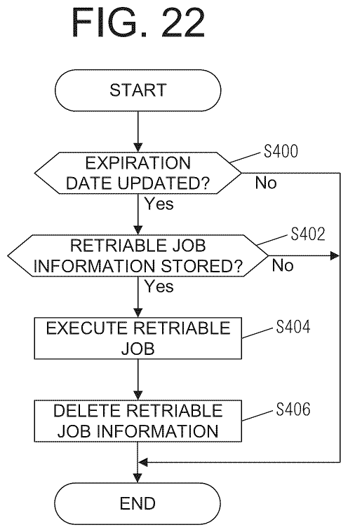

In the present embodiment, the image forming apparatus 12 executes retriable job automatic execution processing illustrated in FIG. 22 instead of the retriable job execution processing illustrated in FIG. 19. The retriable job automatic execution processing is processing to automatically execute the retriable job.

The processing illustrated in FIG. 22 will be described. First, the controller 100 determines whether the expiration date of the token has been updated (step S400).

If determining that the expiration date of the token has not been updated, the controller 100 terminates the processing illustrated in FIG. 22 (step S400; No). On the other hand, if determining that the expiration date of the token has been updated, the controller 100 determines whether the retriable job information, which corresponds to t the retriable job using the token, is stored in the retriable job information storage area 176 (step S400; Yes→step S402).

If determining that the retriable job information is stored, the controller 100 executes the retriable job on the basis of the retriable job information (step S402; Yes→step S404). Then, the controller 100 deletes the retriable job information, which corresponds to the retriable job executed in step S404, from the retriable job information storage area 176 (step S406). If the controller 100 determines that the retriable job information, which corresponds to the retriable job using the token whose expiration date is updated, is not stored, the processing in step S404 and step S406 is omitted (step S402; No).

As described above, the image forming apparatus according to the present embodiment executes the retriable job at the timing when the expiration date of the token is updated. Therefore, user convenience can be improved.

### 5. Fifth Embodiment

A fifth embodiment is an embodiment in which the image forming apparatus 10 described in the first embodiment displays, in addition to the first message, an identifier (for example, an icon, a number, a character, a note, a message, or the like) that is information for identifying presence of the token expiring soon.

### 5.1 Processing Flow

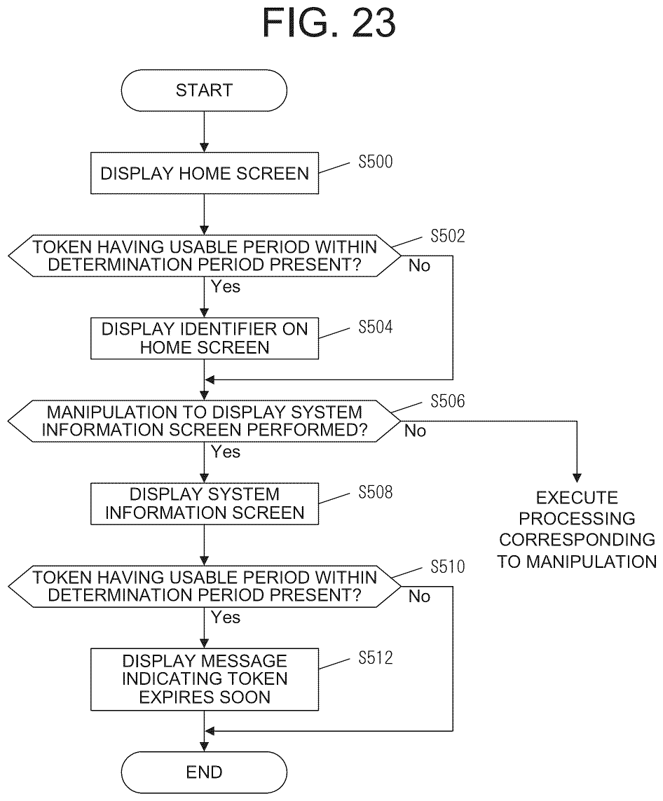

In the present embodiment, the controller 100 further executes processing illustrated in FIG. 23 in addition to the processing illustrated in FIGS. 9 to 11 of the first embodiment.

The processing illustrated in FIG. 23 will be described. First, the controller 100 displays a home screen on the display device 140 (step S500). The home screen is a screen for accepting a manipulation to select a function to be used and displaying the state of the image forming apparatus 10. The controller 100 displays the home screen, for example, when the image forming apparatus 10 is powered on, when the image forming apparatus 10 recovers from the standby (sleep) state, or when the user performs a manipulation to display the home screen.

Next, the controller 100 refers to the token information stored in the token information storage area 168, and determines whether there is a token whose usable period is within the determination period (step S502).

If determining that there is the token whose usable period is within the determination period, the controller 100 displays an identifier indicating that there is the token that expires soon (step S502; Yes→step S504). In the present embodiment, an icon illustrated in the drawing will be described as an example of the identifier. Here, the identifier may be any display that can be identified by the user, and may be a character, a number, a symbol, or the like instead of the icon. If the controller 100 determines that there is no token whose usable period is within the determination period, the processing in step S504 is omitted (Step S502; No).

Next, the controller 100 determines whether the user has performed a manipulation to display a system information screen (step S506). The system information screen is a screen for displaying detailed information on the image forming apparatus 10. For example, as the detailed information on the image forming apparatus 10, information indicating the state of the image forming apparatus 10, information indicating the content of the setting of the image forming apparatus 10, and a notification (message) to the user are displayed in a list on the system information screen. For example, the controller 100 displays a button for displaying the system information screen on the display device 140. Then, when the button is selected, the controller 100 determines that a manipulation to display the system information screen is performed.

If determining that the manipulation to display the system information screen has been performed, the controller 100 displays the system information screen on the display device 140 (step S506; Yes→step S508). If determining that a manipulation other than the manipulation to display the system information screen has been performed, the controller 100 executes processing corresponding to the manipulation (step S506; No).

Next, if determining that there is the token whose usable period is within the determination period, the controller 100 displays, on the system information screen, a message (third message) indicating that there is the token whose usable period is within the determination period (step S510; Yes→step S512). That is, the third message is a message indicating that there is the token that expires soon. If the controller 100 determines that there is no token whose usable period is within the determination period, the processing in step S512 is omitted (Step S510; No).

### 5.2 Operation Example

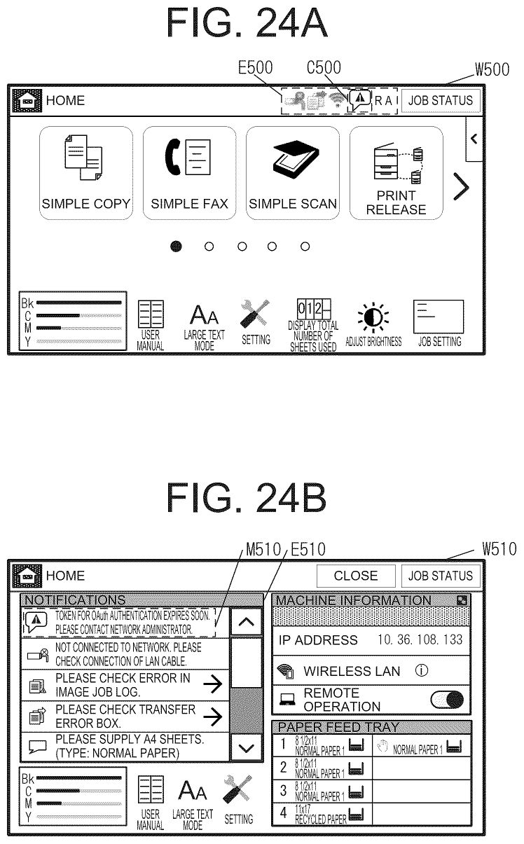

FIGS. 24A and 24B are views, each of which illustrates a screen example of a screen displayed on the display device 140 of the image forming apparatus 10. FIG. 24A is a view illustrating a screen example of a home screen W500. On the home screen W500, for example, a notification area E500 may be provided in which an icon corresponding to the state of the image forming apparatus 10 or a content of a notification to the user. In the case where there is the token whose usable period is within the determination period, an identifier (for example, an icon C500) is displayed in the notification area E500 to indicate that there is the token whose usable period is within the determination period. Even in the case where the pop-up window E100 illustrated in FIG. 12A is not displayed, the user can grasp that there is the token whose usable period is within the determination period by looking at the icon C500.

FIG. 24B is a view illustrating a screen example of a system information screen W510. The system information screen W510 includes an area E510 (notification area) for displaying the content of the notification to the user. In the case where there is the token whose usable period is within the determination period, a message M510 indicating that there is the token whose usable period is within the determination period is displayed in the area E510. By reading the message M510, the user can grasp that there is the token whose usable period is within the determination period.

The icon C500 may be displayed on a screen other than the home screen, or may be displayed in an area other than the notification area E500. The screen or the area where the icon C500 is displayed may be determined in advance or may be set by the user.

As described above, by displaying the identifier, the image forming apparatus according to the present embodiment enables the user to further reliably grasp that there is the token that expires soon.

### 6. Sixth Embodiment

A sixth embodiment is an embodiment in which processing to further display an icon or a message indicating that there is the retriable job is executed in the image forming apparatus 12 described in the third embodiment.

### 6.1 Processing Flow

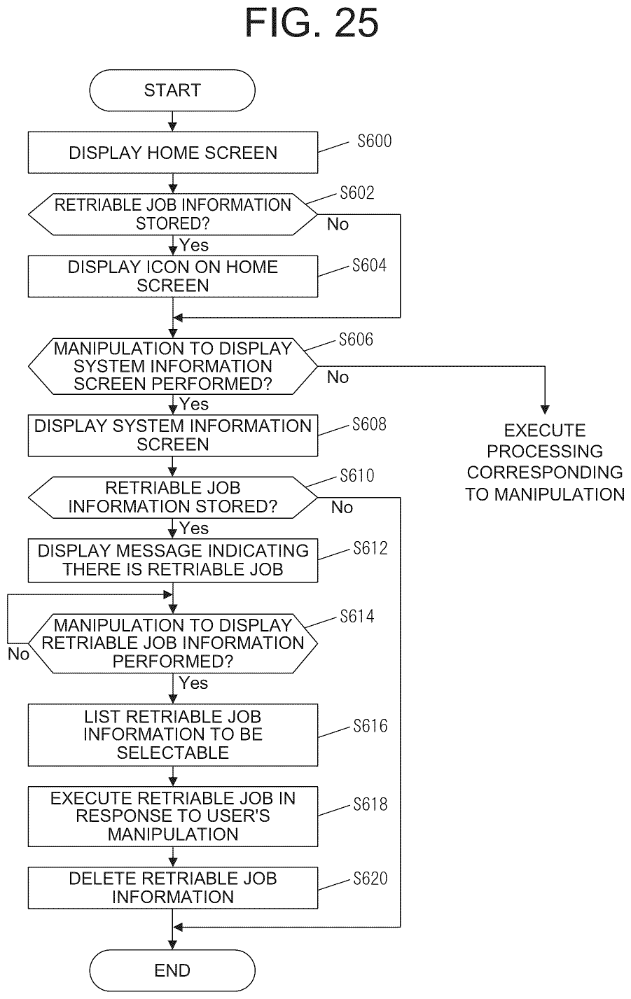

In the present embodiment, the controller 100 further executes processing illustrated in FIG. 25 in addition to the processing illustrated in FIGS. 9 to 11 of the first embodiment and the processing illustrated in FIGS. 17 to 19 of the third embodiment.

The processing illustrated in FIG. 25 will be described. First, the controller 100 displays the home screen (step S600), and determines whether the retriable job information is stored in the retriable job information storage area 176 (step S602).

If determining that the retriable job information is stored, the controller 100 displays, on the home screen, an icon indicating that there is the retriable job (step S602; Yes→step S604). On the other hand, if the controller 100 determines that the retriable job information is not stored, the processing in step S604 is omitted (step S602; No).

Next, if determining that the user has performed the manipulation to display the system information screen, the controller 100 displays the system information screen on the display device 140 (step S606; Yes→step S608). On the other hand, if determining that a manipulation other than the manipulation to display the system information screen has been performed, the controller 100 executes processing that corresponds to the manipulation (step S606; No).

Next, if determining that the retriable job information is stored in the retriable job information storage area 176, the controller 100 displays a message (fourth message) indicating that there is the retriable job on the system information screen (step S610; Yes→step S612).

Next, if determining that the user has performed the manipulation to display the retriable job information, the controller 100 displays a list of the retriable job information stored in the retriable job information storage area 176 in the selectable manner (step S614; Yes→step S616). For example, in step S614, the controller 100 may display a detail button for checking the retriable job information and a message indicating that there is the retriable job. In this case, when the user selects the detail button, the controller 100 determines that the manipulation to display the retriable job information has been performed. On the other hand, if the controller 100 determines that the user has not performed the manipulation to display the retriable job information, the controller 100 repeatedly executes the processing in step S614 (step S614; No).

Next, the controller 100 executes the retriable job in response to the user's manipulation. (step S618). The processing in step S618 is the same as the processing from step S374 to step S380 in FIG. 19. Then, the controller 100 deletes the retriable job information that corresponds to the executed retriable job from the retriable job information storage area 176 (step S620).

### 6.2 Operation Example

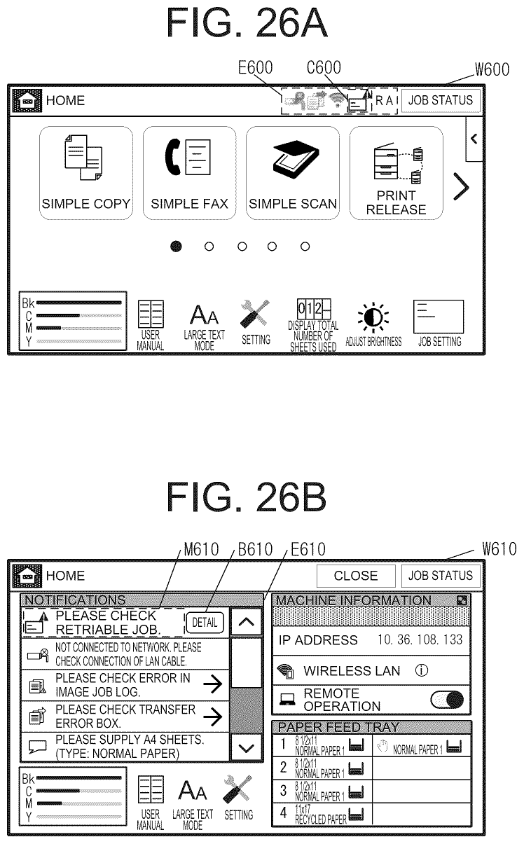

FIG. 26A is a view illustrating a screen example of a home screen W600. A notification area E600 may be provided on the home screen W600. In this case, when the retriable job information is stored in the retriable job information storage area 176, an icon C600 indicating that the retriable job information is stored, that is, there is the retriable job is displayed in the notification area E600. Thus, the user can grasp that there is the retriable job by looking at the icon C600.

The icon C600 may be displayed on a screen other than the home screen, or may be displayed in an area other than the notification area E600. The screen or the area where the icon C600 is displayed may be determined in advance or may be set by the user.

FIG. 26B is a view illustrating a screen example of a system information screen W610. The system information screen W610 includes an area E610 (notification area) for displaying the content of the notification to the user. In the case where the retriable job information is stored, a message M610 indicating that there is the retriable job is displayed in the area E610. Thus, the user can grasp that there is the retriable job by reading the message M610.

In addition, a detail button B610 may be displayed in addition to the message M610. In this case, when user selects the detail button B610, the screen W320 illustrated in FIG. 21 is displayed. The user can transmit the scan data again by executing the retriable job via the screen W320.

### 6.3 Modified Examples of Present Embodiment

The above description has been made that the image forming apparatus 12 notifies the user that the retriable job information is stored (there is the retriable job) by displaying the icon and the message. Here, in the case where there is the date and time designated transmission job, the execution of which fails due to the expiration date of the token, the image forming apparatus 12 may display the icon on the home screen or display the message on the system information screen.

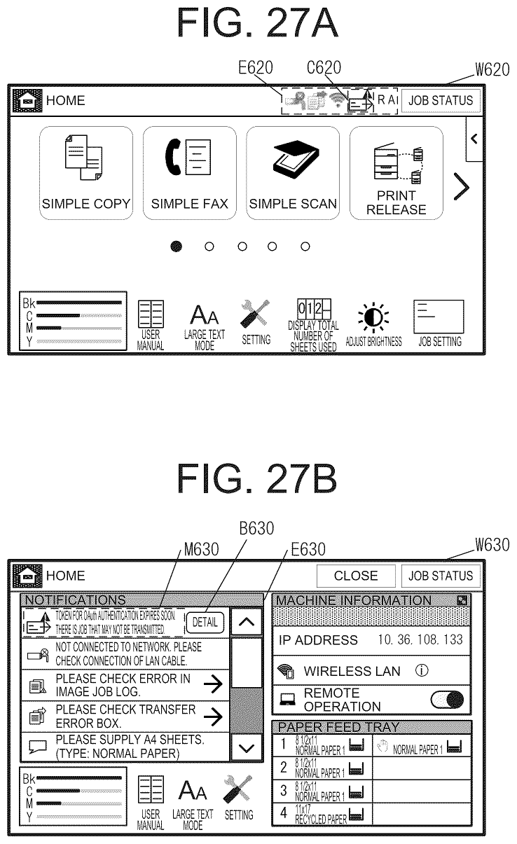

For example, FIG. 27A is a view illustrating a screen example in the case where an icon C620 indicating that there is the date and time designated transmission job, the execution of which fails due to the expiration date of the token, is displayed in a notification area E620 of the home screen W620. FIG. 27B is a view illustrating a screen example of a system information screen W630 in which a message M630 indicating that there is the date and time designated transmission job, the execution of which fails due to the expiration date of the token, is displayed in an area E630 (notification area) for displaying the content of the notification to the user. By looking at the icon C620 or the message M630, the user can grasp that there is the date and time designated transmission job, the execution of which fails due to the expiration date of the token. Thus, the user can change the transmission date and time of the date and time designated transmission job.

In addition to the message M630, a detail button B630 may be displayed. When the detail button B630 is selected, a screen for displaying the list of the date and time designated transmission job information in a selectable manner may be displayed. In this case, the date and time designated transmission job, which corresponds to the date and time designated transmission job information selected by the user, may be executed on the spot, or the transmission date and time thereof may be changeable.

As described above, according to the image forming apparatus of the present embodiment, it is possible to cause the user to further reliably check that there is the retriable job or there is the date and time designated transmission job that possibly fails.

### 7. Modifications

The present disclosure is not limited to each of the above-described embodiments, and various modifications may be made. That is, the technical scope of the present disclosure also includes an embodiment obtained by combining technical measures modified as appropriate without departing from the gist of the present disclosure. In each of the above-described embodiments, the description has been made on the case where the information processing apparatus according to the present disclosure is applied to the image forming apparatus. However, the information processing apparatus according to the present disclosure may be applied to any apparatus that uses the resource managed by the resource server by using the token. For example, the information processing apparatus according to the present disclosure may be applied to a display apparatus that displays information on the basis of the resource managed by the resource server or an image reading apparatus that can transmit the scan data to the resource server.

Some parts of the above-described embodiments are described separately for convenience of the description. However, it is obvious that the embodiments may be combined to be executed within the technically possible range. For example, the fifth and sixth embodiments may be combined. In this case, in the image forming apparatus, it is possible to acknowledge that the period until the expiration date of the token is within the determination period and that there is the retriable job by looking at the home screen or the system information screen. Furthermore, it may be selectable whether the retriable job is executed by the user's manipulation or automatically executed on the basis of the expiration date of the token by combining the third embodiment and the fourth embodiment.

In the above-described embodiments, the description has been made on the case where the information processing apparatus according to the present disclosure is applied to the image forming apparatus. However, the information processing apparatus according to the present disclosure may be applied to the server device or a terminal device such as the smartphone. For example, the present disclosure may be realized as an application that executes the same processing as the processing described in the above-described embodiment, and the application may be executed by the terminal device.

The program that is operated in each of the above-described apparatuses may be recorded in a non-transitory computer-readable medium and provided. In addition, the program operated in each of the apparatuses in the embodiment is a program (a program causing a computer to function) that controls the CPU or the like in a manner to implement the functions in the above-described embodiments. Furthermore, the information handled by these apparatuses is temporarily stored in a temporary storage device (for example, RAM) at the time of processing, and thereafter, is stored in the storage device such as various read only memories (ROMs), and HDDs, and is read, corrected, and written by the CPU when necessary.

The recording medium for storing the program may be any of a semiconductor medium (such as the ROM or a non-volatile memory card), an optical or magneto-optical recording medium (such as a digital versatile disc (DVD), a magneto-optical disc (MO), a mini disc (MD), a compact disc (CD), or a Blu-ray® disc (BD)), and a magnetic recording medium (such as a magnetic tape or a flexible disc). In addition, not only the functions in the above-described embodiments are implemented by executing the loaded program, but also the functions in the present disclosure may be implemented by processing the program jointly with an operating system, other application program(s), or the like on the basis of the instruction of the program.

Furthermore, in the case of distributing the program in the market, the program can be stored in a portable recording medium and distributed, or can be transferred to a server computer connected via the network such as the Internet. In this case, it is needless to say that a storage device of the server computer is also included in the present disclosure.

Moreover, the functional blocks or various features of the apparatuses used in the above-described embodiments may be implemented or executed as an electrical circuit such an integrated circuit or a plurality of integrated circuits. The electrical circuit designed to implement the functions described in the present specification may include a general-purpose processor, a digital signal processor (DSP), an application-specific integrated circuit (ASIC), a field programmable gate array (FPGA), or another programmable logic device, a discrete gate or transistor logic, discrete hardware components, or a combination of these. The general-purpose processor may be a microprocessor, or a conventional processor, controller, microcontroller, or state machine. The electrical circuit described above may include a digital circuit or an analog circuit. In the case where an integrated circuit technology that replaces the current integrated circuit emerges as a result of advances in semiconductor technology, one or more aspects of the present disclosure can also use a new integrated circuit based on such technology.

What is claimed is:

1. An information processing apparatus comprising:
one or more controllers; and
a display device, wherein
the one or more controllers
acquire a token from a server, and
display, on the display device, a first message indicating that the token expires soon in the case where a period for which the token can be used is within a determination period.

2. The information processing apparatus according to claim 1, wherein
in the first message, the one or more controllers display whether or not perform a manipulation to update an expiration date of the token in a selectable manner.

3. The information processing apparatus according to claim 2, wherein
in the case where it is selected not to perform the manipulation to update the expiration date of the token, the one or more controllers display whether to automatically update the expiration date of the token in a selectable manner when the token expires.

4. The information processing apparatus according to claim 3, wherein
in the case where the expiration date of the token is automatically updated upon expiration of the token, the one or more controllers automatically update the expiration date of the token by using information acquired in advance when the token expires.

5. The information processing apparatus according to claim 1, wherein
when the token expires, the one or more controllers transmit, to an apparatus used by a user, information used to update the expiration date of the token remotely.

6. The information processing apparatus according to claim 1, wherein
in the case where a job, an execution date and time of which is designated, is reserved, and the date and time is later than the expiration date of the token, the one or more controllers display, on the display device, a second message indicating that the reserved job possibly fails.

7. The information processing apparatus according to claim 6, wherein
in the case where the token expires at the time of executing the job, the one or more controllers store the job as a retriable job.

8. The information processing apparatus according to claim 7, wherein
the one or more controllers display a list of the retriable jobs on the display device, and executes the retriable job selected by a user.

9. The information processing apparatus according to claim 7, wherein
the one or more controllers execute the retriable job when the expiration date of the token is updated.

10. The information processing apparatus according to claim 1, wherein
in the case where there is the token whose usable period is within a determination period, the one or more controllers display, on the display device, an identifier indicating that there is the token whose usable period is within the determination period.

11. The information processing apparatus according to claim 1, wherein
in the case where there is the token whose usable period is within a determination period, the one or more controllers display, on the display device, a third message indicating that there is the token whose usable period is within the determination period.

12. The information processing apparatus according to claim 7, wherein
in the case where there is the retriable job, the one or more controllers display an identifier indicating that there is the retriable job, on a screen displayed in the display device.

13. The information processing apparatus according to claim 7, wherein
in the case where there is the retriable job, the one or more controllers display a fourth message indicating that there is the retriable job, on a screen displayed in the display device.

14. The information processing apparatus according to claim 13, wherein
the one or more controllers display a button for displaying a list of the retriable jobs together with the fourth message, and displays the list of the retriable jobs on the display device when the button is selected.

15. A display control method for an information processing apparatus, the display control method comprising:
displaying, on a display device, a first message indicating that a token acquired from a server expires soon in the case where a period for which the token can be used is within a determination period.
